(19) United States
(12) Patent Application Publication
(10) Pub. No.: US 2026/0243241 A1
(43) Pub. Date: Aug. 20, 2026

(54) FUEL COMPRESSOR

(71) Applicant: PHINIA DELPHI LUXEMBOURG SARL, Belvaux (LU)

(72) Inventor: Diego GUERRATO, Gillingham (GB)

(21) Appl. No.: 19/156,194

(22) PCT Filed: Feb. 14, 2024
(86) PCT No.: PCT/EP2024/053774

§ 371 Date: Aug. 13, 2025

(30) Foreign Application Priority Data
Feb. 14, 2023 (GB) 2302103.3

(51) Int. Cl. F04B 25/02; F02M 21/02; F02M 59/02; F02M 59/10; F02M 59/46; F04B 37/18; F04B 39/00

(52) U.S. Cl. CPC F04B 25/02; F02M 21/0245; F02M 59/027; F02M 59/102; F02M 59/464; F04B 37/18; F04B 39/0005

(57) ABSTRACT

A fuel compressor for compressing gaseous vehicle fuel, includes: a housing; a piston arranged for reciprocating movement along a piston axis within the housing; a drive arrangement arranged to drive reciprocating movement of the piston along the piston axis a first compression chamber in which gaseous fuel is compressed by movement of the piston in a first direction along the piston axis, in use; and a second compression chamber in which gaseous fuel is compressed by movement of the piston in a second direction along the piston axis in use. The first and second compression chambers are mutually spaced along the piston axis so that the first and second compression chambers are arranged at opposed ends of the piston.

### FIELD OF THE INVENTION

This invention relates to a compressor for use in a fuel delivery arrangement for gaseous vehicle fuel. In particular, the invention relates to a fuel compressor for delivering gaseous fuel such as hydrogen to an internal combustion engine.

### BACKGROUND

As automotive vehicles transition away from reliance on fossil fuels, internal combustion engines that consume gaseous fuels such as hydrogen instead of liquid fuels are gaining interest. Such engines require fuel delivery arrangements configured to handle the gaseous fuel, which systems may have similar architectures to traditional systems for liquid fuels, but with modifications to account for the different challenges that the use of gaseous fuel presents.

For example, it has been found that it is beneficial to engine performance to inject gaseous fuel at pressures greatly exceeding atmospheric pressure, for example at a pressure of approximately 300 bar. Although gaseous fuel may be held at high pressure in a vehicle fuel tank, for example at a pressure of around 700 bar when the tank is full, this pressure reduces rapidly as the tank is depleted, potentially to as low as 30 bar as the tank empties.

Accordingly, a fuel compressor is required to pressurise the fuel supplied from the fuel tank when the fuel tank pressure drops below that required by the injectors. It follows that the fuel compressor and the associated fuel delivery arrangement may need to be capable of handling a wide variation in its pressure ratio, namely the ratio of the output pressure to the input pressure, whilst delivering a demanded mass flow rate of fuel, since the input pressure varies widely while the output pressure may remain substantially constant. This is further complicated by the fact that a compressor would typically be driven by the engine and hence the compressor speed is directly related to the engine speed, whereas the required mass flow rate of fuel is dictated by the engine torque demand.

Another challenge is that mixing of the gaseous fuel with oil should be avoided, which may militate against the use of traditional lubrication techniques for the compressor components.

In addition, a compressor typically needs to increase in size to handle a higher pressure ratio. Thus, the space consumed by the compressor may need to be balanced against the minimum pressure allowed in the fuel tank, which in turn may impact storage effectiveness.

It is against this background that the invention has been devised.

### STATEMENTS OF INVENTION

According to an aspect of the present invention, there is provided a fuel compressor for compressing gaseous vehicle fuel such as hydrogen. The fuel compressor comprises: a housing; a piston arranged for reciprocating movement along a piston axis within the housing; a drive arrangement arranged to drive reciprocating movement of the piston along the piston axis; a first compression chamber in which gaseous fuel is compressed by movement of the piston in a first direction along the piston axis, in use; and a second compression chamber in which gaseous fuel is compressed by movement of the piston in a second direction along the piston axis, in use. The first and second compression chambers are mutually spaced along the piston axis so that the first and second compression chambers are arranged at opposed ends of the piston. The first and second directions are mutually opposed.

Configuring the compressor with dual compression chambers arranged at opposed ends of a shared piston promotes a compact topology for the compressor. Also, the forces generated in the compression chambers balance one another to some extent and so reduce the overall forces that the components of the compressor are subjected to.

Each compression chamber may be at least partially enclosed by the piston.

The piston may include a first end face at a first end of the piston and a second end face at a second end of the piston opposite the first end. The first end face may include a first recess that at least partially defines the first compression chamber, and the second end face may include a second recess that at least partially defines the second compression chamber.

Each recess may define a cylindrical volume. Each recess may be circular.

The piston may be generally cylindrical. The piston may have a relatively consistent diameter along its length.

The first and second compression chambers may be located inside the piston.

The drive arrangement may comprise a drive cam arranged to rotate about a drive axis to drive reciprocating movement of the piston along the piston axis. The compressor may comprises a yoke mounted to the drive cam and in sliding engagement with the piston. The piston axis may be orthogonal to the drive axis. The piston axis and the drive axis may intersect.

At least part of the drive arrangement may be received within the piston.

The compressor may comprise an oil diverting arrangement configured to divert oil flowing from the drive arrangement away from the compression chambers. The oil diverting arrangement may comprise at least one vent passage through which a flow of air is conveyed, in use, to divert oil away from the compression chambers. The, or each, vent passage optionally extends axially through the piston. The oil diverting arrangement may comprise one or more chambers positioned to intercept oil flowing from the drive arrangement, the or each chamber being in fluid communication with the vent passage(s). The chambers may be formed in the piston, for example.

The compressor may comprise: a first inlet valve through which fuel is supplied to the first compression chamber, in use; a first outlet valve through which compressed fuel is discharged from the first compression chamber, in use; a second inlet valve through which fuel is supplied to the second compression chamber, in use; and a second outlet valve through which compressed fuel is discharged from the second compression chamber, in use. The inlet and outlet valves may be non-return valves, for example, and may be received in, or may define, respective ports of the compressor. An axis parallel to the piston axis may intersect the first and second inlet valves. An axis parallel to the piston axis may intersect the first and second outlet valves.

The compressor may comprise a first head member through which fuel flows into and out from the first compression chamber, and a second head member through which fuel flows into and out from the second compression chamber.

The first head member may include a first spigot, and the second head member may include a second spigot. The first recess and the first spigot may define the first compression chamber, and the second recess and the second spigot may define the second compression chamber.

The first spigot may be received within the first recess, and the second spigot may be received within the second recess.

The first and second head members may each be supported for movement relative to the housing. The first head member may carry a first inlet port and/or a first inlet valve, and a first outlet port and/or a first outlet valve. The second head member may carry a second inlet port and/or a second inlet valve, and a second outlet port and/or a second outlet valve.

The piston may be shaped to define each compression chamber, at least partially.

The drive arrangement may be arranged to be coupled to, and driven by, a vehicle engine.

Another aspect of the invention provides a fuel delivery arrangement, comprising: the compressor of the above aspect; an inlet line arranged to convey fuel from a reservoir to each of the compression chambers of the compressor; and an outlet line arranged to receive fuel discharged from each of the compression chambers of the compressor. If the fuel delivery arrangement is used in the context of a vehicle, the reservoir may be a fuel tank of the vehicle, for example, and the arrangement may be configured to deliver fuel to an engine of the vehicle.

The fuel delivery arrangement may comprise a bypass line that extends between the inlet line and the outlet line, the bypass line comprising a valve configured to regulate fuel flow through the bypass line. If present, the bypass line may provide a flow path that bypasses one or more compression chambers of the compressor. For example, the bypass line may extend around the compressor. The bypass line and the bypass valve may enable a range of operating modes for the arrangement. For example, the bypass line may be used to bypass the compressor when fuel in the inlet line is at a sufficient pressure for the ultimate recipient of the fuel, for example a vehicle engine. The bypass line may also allow for an idling mode of operation for the compressor, by creating a fluid short circuit that connects the compressor output to its input. This can be exploited to regulate the effective output from the compressor to the outlet line, for example by switching the state of the bypass valve rapidly to control the compressor output in a manner analogous to pulse-width modulation.

The fuel delivery arrangement may be configured to switch the bypass valve between open and closed states at a frequency proportionate to an operating speed of the compressor. The fuel delivery arrangement may be configured to switch the bypass valve between open and closed states in synchronisation with compression events in the compressor. In such embodiments, the fuel delivery arrangement may be configured to switch the state of the bypass valve only as compression events commence or complete.

The fuel delivery arrangement may be configured to vary the switching frequency of the bypass valve to control characteristics of the fuel flowing to a fuel recipient connected to the outlet line, for example the fuel pressure or flow rate. The fuel recipient may be an engine or a fuel injection system associated with an engine, for example. Alternatively, the fuel recipient could be a buffer volume.

The fuel delivery arrangement may comprise an electromechanical actuator for switching the bypass valve between open and closed states. Switching of the bypass valve may be controlled by a controller.

The fuel delivery arrangement may comprise a buffer volume connected to the outlet line, the buffer volume being configured to accommodate expansion and compression of fuel to mitigate pressure variations in the outlet line. By absorbing fluctuations in pressure in the outlet line, the buffer volume, which may be in the form of a tank for example, may add refinement and/or compensate for any misalignment between the compressor output and the demand. The buffer volume may be configured to hold and release compressed fuel selectively. The buffer volume may be configured to hold fuel at a pressure above a threshold level and/or within a target pressure range. If the compressor is driven by a vehicle engine, the buffer volume may be configured to hold fuel at pressure when the vehicle engine is inactive.

The fuel delivery arrangement may comprise a valve such as a non-return valve disposed on the outlet line downstream of a junction between the outlet line and the bypass line.

The fuel delivery arrangement may be configured such that the compressor can be activated and deactivated selectively.

The fuel delivery arrangement may comprise a disengageable coupling through which torque is transmitted to the compressor to drive the compressor. Disengaging the coupling may deactivate the compressor. The disengageable coupling may comprise a clutch, for example.

The fuel delivery arrangement may be configured to switch the bypass valve between open and closed states while the compressor operates, to control characteristics of the fuel flowing to a fuel recipient connected to the outlet line, for example the buffer volume. The fuel delivery arrangement may be configured to vary a proportion of compression strokes of the compressor for which the bypass valve is in an open state, relative to the compression strokes for which the bypass valve is in a closed state, to control characteristics of the fuel flowing to the fuel recipient.

Another aspect of the invention provides a vehicle arrangement comprising the fuel delivery arrangement of the above aspect. The vehicle arrangement may comprise a reservoir such as a fuel tank connected to the inlet line of the fuel delivery arrangement. The vehicle arrangement may also include a fuel recipient to which the fuel delivery arrangement delivers fuel. The fuel recipient may be an engine or a fuel injection system associated with an engine, for example. Alternatively, the fuel recipient could be the buffer volume. The vehicle arrangement may also comprise a controller for controlling operation of the fuel delivery arrangement, for example to control operation of the bypass valve.

Another aspect of the invention provides a method of compressing gaseous vehicle fuel such as hydrogen. The method comprises moving a piston in a first direction along a piston axis to compress gaseous fuel in a first compression chamber, and moving the piston in a second direction along the piston axis to compress gaseous fuel in a second compression chamber.

Another aspect of the invention provides a fuel delivery arrangement for gaseous vehicle fuel such as hydrogen. The arrangement comprises: a fuel compressor; an inlet line arranged to convey fuel from a reservoir to the compressor; an outlet line arranged to receive fuel discharged from the compressor; a bypass line that extends between the inlet line and the outlet line; and a bypass valve disposed on the bypass line. The bypass valve is configured to open and close the bypass line to fuel flow. If the fuel delivery arrangement is used in the context of a vehicle, the reservoir may be a fuel tank of the vehicle, for example, and the arrangement may be configured to deliver fuel to an engine of the vehicle.

Another aspect of the invention provides a method of compressing gaseous vehicle fuel such as hydrogen. The method comprises: conveying fuel through an inlet line to a compressor; discharging fuel from the compressor to an outlet line connected to a fuel recipient; and operating a bypass valve to open and close a bypass line that extends between the inlet line and the outlet line, to control characteristics of the fuel flowing to the fuel recipient.

The fuel recipient may be an engine or a fuel injection system associated with an engine, for example. Alternatively, the fuel recipient could be a buffer volume.

The method may comprise switching the bypass valve between open and closed states at a frequency proportionate to an operating speed of the compressor. The method may comprise switching the state of the bypass valve in synchronisation with compression events in the compressor. The method may comprise switching the state of the bypass valve only as compression events commence or complete.

The method may comprise operating the compressor simultaneously with operating the bypass valve to open and close the bypass line, to control characteristics of the fuel flowing to the fuel recipient.

The method may comprise varying a proportion of compression strokes of the compressor for which the bypass valve is in an open state, relative to the compression strokes for which the bypass valve is in a closed state, to control characteristics of the fuel flowing to the fuel recipient.

The method may comprise varying the switching frequency of the bypass valve to control characteristics of the fuel flowing to a fuel recipient connected to the outlet line.

Another aspect of the invention provides a controller configured to perform the method of the above aspect to control operation of a fuel delivery arrangement for gaseous vehicle fuel, for example the fuel delivery arrangement of the above aspect.

Another aspect of the invention provides a controller configured to control operation of a fuel delivery arrangement for gaseous vehicle fuel. The controller is configured to: operate a compressor to discharge fuel to an outlet line connected to a fuel recipient, the fuel having been conveyed to the compressor through an inlet line; and operate a bypass valve to open and close a bypass line that extends between the inlet line and the outlet line, to control characteristics of the fuel flowing to the fuel recipient. The controller may form part of the vehicle arrangement of the above aspect.

The invention also extends to a vehicle comprising the compressor or the fuel delivery arrangement or the vehicle arrangement of the above aspects.

It will be appreciated that the various features of each aspect of the invention are equally applicable to, alone or in appropriate combination, the other aspects of the invention also.

### BRIEF DESCRIPTION OF THE DRAWINGS

The above and other aspects of the invention will now be described, by way of example only, with reference to the accompanying drawings, in which:

FIG. 1 is a schematic diagram of a vehicle arrangement including a fuel delivery arrangement for gaseous fuel;

FIG. 2 is a detail view of a fuel compressor of the fuel delivery arrangement of FIG. 1;

FIG. 3 corresponds to FIG. 2 but shows the fuel compressor in cross section;

FIG. 4 corresponds to FIG. 3 but has selected components hidden;

FIG. 5 is a detail view of a drive arrangement of the fuel compressor of FIG. 2;

FIG. 6 is a detail view of a driveshaft assembly of the fuel compressor of FIG. 2; and

FIG. 7 is a detail view of a driveshaft of the fuel compressor of FIG. 2.

### SPECIFIC DESCRIPTION

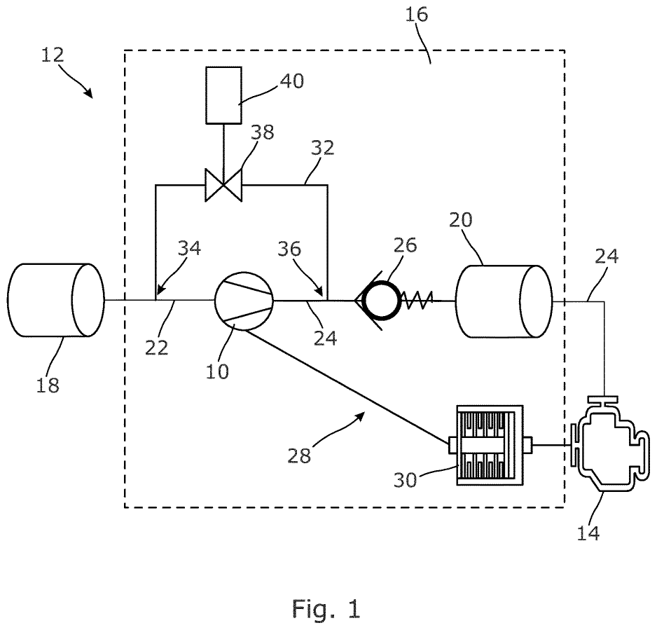

FIG. 1 shows a gaseous fuel compressor 10 according to an embodiment of the invention in the context of a vehicle arrangement 12 that also comprises an internal combustion engine 14. The compressor 10 forms part of a fuel delivery arrangement 16 that is configured to deliver gaseous fuel from a fuel tank 18 to the engine 14, specifically hydrogen fuel in this embodiment.

It is noted, however, that compressors according to the invention may be used in a wide range of applications and so the arrangement shown in FIG. 1 is purely an example. Indeed, in some embodiments compressors may find application outside the context of a vehicle, for example in fuelling stations.

In addition to the compressor 10, the fuel delivery arrangement 16 of FIG. 1 also includes a control arrangement that is configured to regulate operation of the compressor 10, and a buffer volume or tank 20.

The engine 14 includes a fuel injection system that comprises a set of fuel injectors that each delivers fuel to a respective cylinder of the engine 14 in use. Although not shown in the figures, the fuel injection system may also include an accumulator, or ‘common rail’, that holds a reserve of pressurised fuel to be drawn by the injectors, as is known.

The fuel tank 18 holds fuel and so acts as a fuel reservoir within the vehicle arrangement 12. In this example, the hydrogen is held in the fuel tank 18 at 700 bar when the fuel tank 18 is full to its maximum capacity, although this pressure reduces as the fuel tank 18 is depleted in use. The fuel tank 18 is equipped with a pressure regulator, or ‘tank valve’, that reduces the pressure of fuel output by the fuel tank 18 to a level slightly above that required by the fuel injection system, for example a pressure of approximately 320 bar in this embodiment. When the pressure inside the fuel tank 18 falls below this level, the tank valve is deactivated and the fuel is output at a pressure corresponding to the pressure inside the fuel tank.

It is noted that multiple fuel tanks may be used in other embodiments.

The fuel compressor 10 includes a pair of inlets that receive gaseous fuel from an inlet line 22 extending from the fuel tank 18. Fuel is conveyed through the inlet line 22 to the compressor inlets at a pressure substantially corresponding to the pressure at which fuel is output from the fuel tank 18, which is 320 bar or below in this example due to the tank valve.

The fuel compressor 10 also includes a pair of outlets that discharge fuel into an outlet line 24 at or above the pressure required by the engine 14, which is approximately 300 bar in this example. A first portion of the outlet line 24 extends to the buffer tank 20, which is configured to hold pressurised fuel received from the compressor 10 until the fuel is required by the engine 14. In this respect, the buffer tank 20 is connected to the fuel injection system by a second portion of the outlet line 24.

The buffer tank 20 is therefore disposed on the outlet line 24 between the compressor outlets and the fuel injection system. In broad terms, the buffer tank 20 is an additional fuel storage tank and may be generally similar to the fuel tank 18 in construction, and so offers additional fuel storage capacity within the fuel delivery arrangement 16. As shall become clearer in the description that follows, in use the buffer tank 20 receives pressurised fuel, either from the compressor 10 or directly from the fuel tank 18, thereby pressurising the buffer tank 20 so that the buffer tank 20 holds a reservoir of fuel at the pressure required by the fuel injection system at all times. Fuel is then released to the fuel injection system from the buffer tank 20 selectively when demanded.

The buffer tank 20 also acts to smooth any variations in the pressure output by the compressor 10, thereby matching the characteristics of the fuel supply more closely to the demand from the engine 14, which is typically relatively steady.

It is noted that the buffer tank 20 may be omitted in other embodiments, so that fuel is delivered directly to the fuel injection system from the fuel compressor 10 or the fuel tank 18. Conversely, in other embodiments more than one buffer tank may be included, arranged in series or in parallel.

It is also noted that the buffer tank 20 is distinct from the accumulator of the fuel injection system, if present. In practical terms, typically the accumulator holds fuel at pressure only while the engine 14 operates, whereas the buffer tank 20 stores fuel at pressure even when the engine 14 is inactive. The volume of the buffer tank 20 is also typically many times greater than that of an accumulator.

A pressure regulator may be placed on an outlet of the buffer tank 20, or on the outlet line 24 downstream of the buffer tank 20, to reduce the pressure of fuel in the outlet line 24 to a level slightly above that required by the fuel injection system, for example a pressure of approximately 320 bar in this embodiment. Such a pressure regulator may be included in addition to, or as an alternative to, the tank valve.

It follows from the above that the buffer tank 20 and the engine 14 may each be considered to define fuel recipients, in that each receives compressed fuel from the fuel delivery arrangement 16. Equally, the buffer tank 20 forms part of the fuel delivery arrangement 16 that supplies compressed fuel to the engine 14.

The outlet line 24 also includes a non-return valve defining an outlet valve 26 that forms part of the control arrangement, as explained further below. The outlet valve 26 is disposed upstream of the buffer tank 20.

In this example, the fuel compressor 10 includes a drive arrangement including a driveshaft (shown and described later), which is driven by the engine 14. More specifically, as shown schematically in FIG. 1, a coupling 28 is provided by which the fuel compressor driveshaft is operably coupled to a crankshaft of the engine 14, such that rotation of the crankshaft as the engine 14 operates drives corresponding rotation of the driveshaft. The coupling 28 therefore transmits torque from the crankshaft to the compressor drive arrangement to provide a motive force for the compressor 10. The fuel compressor 10 of this example is sized for a direct coupling to the engine crankshaft, without a gearbox, so that the driveshaft rotates at the same rotational speed as the crankshaft.

The coupling 28 between the driveshaft and the crankshaft includes a multi-disc clutch 30 that is disposed between the engine 14 and the compressor 10, such that the engine 14 drives the fuel compressor 10 via the clutch 30. The multi-disc clutch 30 facilitates high transmission power without a significant increase in the overall size of the clutch 30, while keeping the activation force low. The clutch 30 may be similar to those known in the motorcycle industry, for example. Mechanical coupling between the clutch 30 and the compressor driveshaft, and between the crankshaft and the clutch 30, may be effected in any suitable manner to transfer torque from the crankshaft to the driveshaft.

The clutch 30 includes a servomechanism that is operable to engage and disengage selectively, for example under the control of an engine control unit (ECU) (not shown in FIG. 1), namely an electronic control unit responsible for managing operation of the engine 14. The ECU may be regarded as part of the vehicle arrangement 12 in this example. In this way, the fuel compressor driveshaft can be coupled to, and decoupled from, the engine 14 at any time during operation, allowing the fuel compressor 10 to be activated and deactivated while the engine 14 operates. For example, the fuel compressor 10 may be disengaged to cease compressing fuel when the fuel pressure in the inlet line 22 is already sufficiently high for the engine 14, in which case the fuel can be conveyed directly to the engine 14 from the fuel tank 18 without requiring any mechanical work from the fuel compressor 10.

In this respect, the fuel delivery arrangement 16 also includes a bypass line 32 that extends between a first end 34, which connects to the inlet line 22, and a second end 36, which connects to the outlet line 24 at a point between the compressor outlets and the outlet valve 26. The bypass line 32 therefore creates a path that allows fuel to bypass the compressor 10, for example to enable fuel to be conveyed directly to the engine 14 from the fuel tank 18 when the fuel discharged from the fuel tank 18 and its tank valve is at a sufficient pressure for the engine 14, which in this example is 320 bar.

The bypass line 32 includes a bypass valve 38 that is operable to switch between open and closed positions, to permit or block flow through the bypass line 32, under the control of the ECU. State changes of the bypass valve 38, between open and closed positions, are driven by a solenoid actuator 40 in this embodiment. The bypass valve 38 is therefore capable of rapid, high-frequency state changes. It is noted that other actuation methods are possible for changing the state of the bypass valve 38.

Typically, the bypass valve 38 is opened while the clutch 30 switches between engaged and disengaged states, to reduce stress on the clutch 30.

When the bypass valve 38 is closed and the clutch 30 is engaged, fuel discharged by the fuel compressor 10 exerts pressure on the outlet valve 26 that generates a force sufficient to open the outlet valve 26. Once the outlet valve 26 opens, fuel flows through the outlet valve 26 and on to the buffer tank 20.

When the bypass valve 38 is open, fuel may flow in either direction through the bypass line 32. The direction of fuel flow depends in part on whether the clutch 30 is engaged.

If the clutch 30 is disengaged so that the fuel compressor 10 is inactive, fuel flows directly from the fuel tank 18 to the outlet valve 26 through the bypass line 32. Since the control arrangement is typically only configured in this way when the fuel output from the fuel tank 18 is already at the pressure required by the fuel injection system, the outlet valve 26 opens and the fuel continues to the buffer tank 20. Thus, fuel is conveyed directly from the fuel tank 18 to the buffer tank 20 in this scenario, bypassing the fuel compressor 10.

When the clutch 30 is engaged so that the fuel compressor 10 operates while the bypass valve 38 is open, the fuel output by the fuel compressor 10 takes the path of least resistance and so flows through the bypass line 32 back to the fuel compressor inlets, and the outlet valve 26 therefore remains closed. When the outlet valve 26 is closed, backflow from the buffer tank 20 into the bypass line 32 or towards the compressor 10 is prevented. The fuel then circulates around the bypass line 32 and the fuel compressor 10, and so between the inlets and the outlets of the compressor 10, remaining at a substantially constant pressure corresponding to the inlet pressure if the pressure losses are sufficiently small.

Accordingly, in this situation the bypass line 32 acts as a fluid short-circuit that effectively causes idling of the fuel compressor 10, defining an idling mode for the compressor 10 in which the fuel is held at the inlet pressure without performing significant compression work. The power consumption of the fuel compressor 10 in the idling mode is therefore minimal, as no mechanical work is performed other than to overcome friction. Conversely, a compressing mode for the compressor 10 is defined when the bypass valve 38 is closed and the clutch 30 is engaged, so that the compressor 10 performs mechanical work on the fuel.

The idling mode of the fuel compressor 10 can be exploited to regulate the pressure and flow rate of fuel output by the compressor 10 and delivered to the buffer tank 20. In this respect, the state of the bypass valve 38 can be changed at high frequency to activate compression intermittently for a desired duty cycle, so that the output pressure and flow rate that is effectively delivered is proportionate to the relative proportions of time for which the compressor 10 acts to compress fuel. For example, the bypass valve 38 may change state at up to the same frequency as the engine speed, which may be up to 3000 revolutions per minute in typical applications, corresponding to a valve switching frequency of up to 50 Hz. The bypass valve 38 may even change state at a higher frequency than the engine speed, for example at double the frequency corresponding to the engine speed to change state with every compression stroke of the compressor 10, as shall become clear from the description that follows later.

The bypass valve 38, the outlet valve 26 and the clutch 30 therefore define the control arrangement, which is configured to modulate the output of the fuel compressor 10 in a manner similar to pulse-width modulated (PWM) control. This enables regulation of the output pressure and flow rate delivered by the compressor 10 to the required level, against varying input pressure and independently of the engine speed.

To maintain efficient idling of the fuel compressor 10, opening and closing of the bypass valve 38 is synchronised with compression strokes performed within the compressor 10, so that the valve is either open or closed throughout each compression stroke and does not change state midway through a stroke. The frequency of state changes for the bypass valve 38 is therefore proportional to the compressor speed. The proportion of compression strokes for which the bypass valve 38 is open relative to the compression strokes for which the bypass valve 38 is closed, which may be regarded as the duty cycle applied to the bypass valve 38, then determines the rate at which fuel is delivered to the buffer tank 20 and thus contributes to holding the pressure in the buffer tank 20 within a desired range.

It is noted that the state of the bypass valve 38 is not necessarily switched at regular intervals. Instead, the switching of the bypass valve 38 is controlled in accordance with the desired duty cycle, this control being implemented by the ECU in this example. For example, the bypass valve 38 may be open for three compression strokes and then closed for a fourth compression stroke, in a repeating pattern, to provide a duty cycle of 25%, noting that compression occurs when the bypass valve 38 is closed. In other words, the compressor 10 operates in the compressing mode for 25% of the time in this scenario. While the bypass valve 38 is controlled in this manner, the state of the bypass valve 38 switches twice for every four cycles of the compressor 10 and so the switching frequency for the bypass valve 38 is proportionate to the compressor speed. In practice, the duty cycle may be varied dynamically to regulate the compressor output as may be appropriate.

In operation, the engine 14 draws fuel from the buffer tank 20 at a rate that is typically relatively steady and continuous in the short-term. Meanwhile, fuel is output from the compressor 10 intermittently in pulses corresponding to compression strokes, when the bypass valve 38 is closed, and so may not match the engine demand precisely. This could lead to pressure variation in the outlet line 24 if the compressor 10 were connected directly to the engine 14. The buffer tank 20 is of a sufficient size that expansion and compression of fuel inside the buffer tank 20, in response to the pulses and intervening gaps in the compressor output, absorbs such pressure variations and so provides a smoothing effect that refines fuel delivery. If a pressure regulator is added at, or downstream of, the outlet of the buffer tank 20, this may enable the size of the buffer tank 20 to reduce. Meanwhile, the bypass valve 38 is operated to align the averaged output of the compressor 10 with the engine demand.

As noted above, the buffer tank 20 may be omitted in other embodiments, for example if the compressor output can be controlled with sufficient accuracy. Omitting the buffer tank 20 may save space within the fuel delivery arrangement 16, for example, and may also improve storage effectiveness.

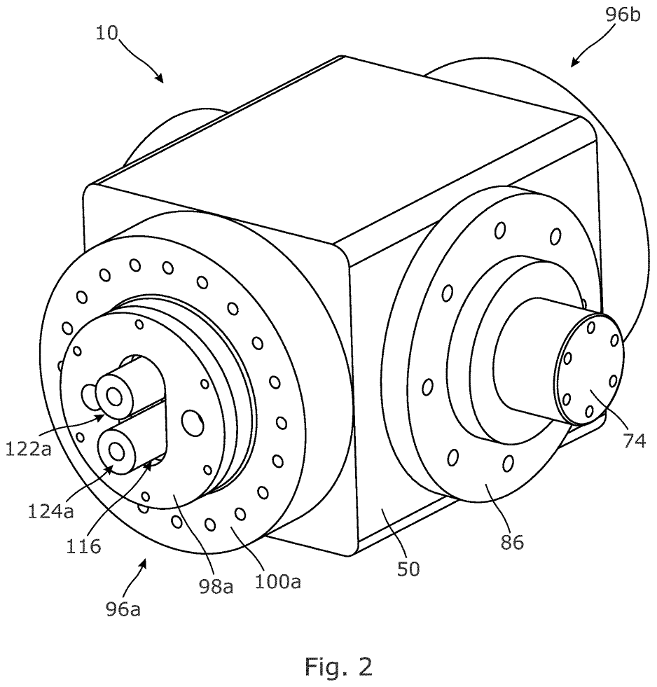

Having described the control arrangement that regulates the compressor output, the fuel compressor 10 itself shall now be described with reference to FIGS. 2 to 7, which are referred to collectively below.

The fuel compressor 10 is generally configured as a positive displacement compressor 10. The compressor 10 is configured to handle a pressure ratio that may be ten or more, in this example, whilst being compact.

The compressor 10 comprises a box-shaped compressor housing 50 having a pair of opposed faces that are generally square, with the remaining four faces of the housing 50 being oblong.

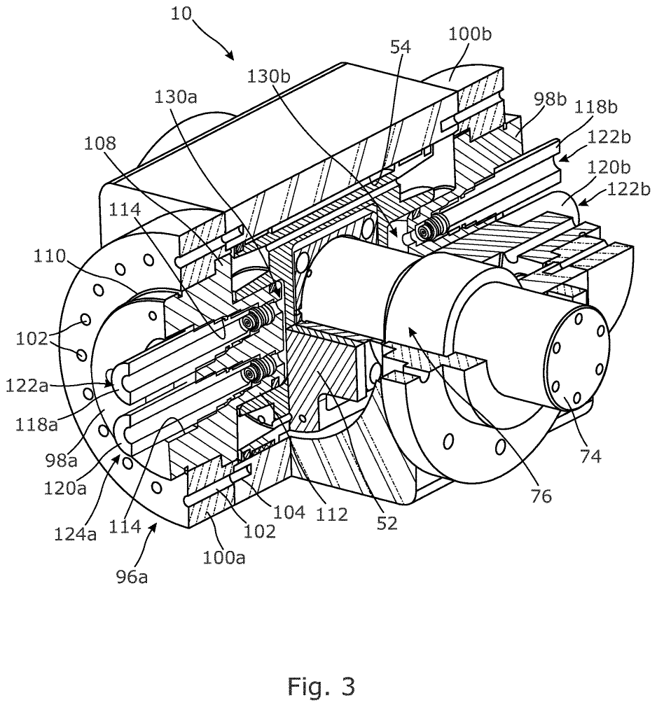

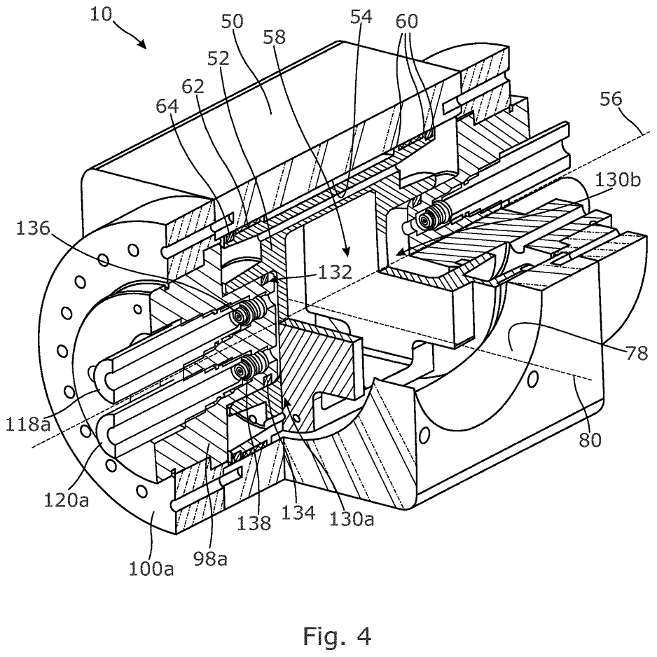

As best seen in FIGS. 3 and 4, the compressor housing 50 includes first and second central through-bores having respective mutually-orthogonal central axes that intersect at the centre of the compressor housing 50, each axis being parallel to four of the six faces of the housing 50. The first central through-bore extends between the square faces of the housing 50, and the second central through-bore extends between a pair of oblong faces of the housing 50.

The first central through-bore accommodates a piston 52, and so the first central through-bore defines a piston bore 54. In turn, the central axis of the piston bore 54 defines a piston axis 56 along which the piston 52 reciprocates back-and-forth in operation, as shall become clear. In this example, the piston bore 54 has a diameter of 60 mm and the piston 52 has a stroke length of 20 mm, although these values are purely illustrative and will vary according to the requirements of each application.

The piston 52 is generally cylindrical and has a hollow centre, defining a piston cavity 58 of generally rectangular cross-section that extends through the piston 52 in the direction of the driveshaft, when assembled. On a tubular exterior surface of the piston 52, each end of the piston 52 includes a respective series of three of axially-spaced radial flanges 60, each series of flanges defining between them a pair of side-by-side annular grooves that extend circumferentially around the piston 52. Each of these pairs of grooves includes a wider groove that holds a guide ring 62 and a narrower groove, which is axially outward of the wider groove with respect to the centre of the compressor housing 50, holds an outer sealing ring 64.

Each guide ring 62 engages, and slides relative to, the inner wall of the piston bore 54 to guide movement of the piston 52. The guide rings 62 may be of PTFE (polytetrafluoroethylene) or another material having a low coefficient of friction, for example.

Although not shown in the figures, the piston 52 also includes a radially-extending pin that is received and slides in a groove formed in the wall of the piston bore 54 that extends parallel to the piston axis 56, the pin restraining the piston 52 against rotation about the piston axis 56. Other arrangements are also possible for restraining rotation of the piston 52.

Each outer sealing ring 64 creates a fluid seal between the piston 52 and the piston bore 54 at each end of the piston 52.

It follows that a radial clearance exists between the piston 52 and the piston bore 54 in the region between the guide rings 62.

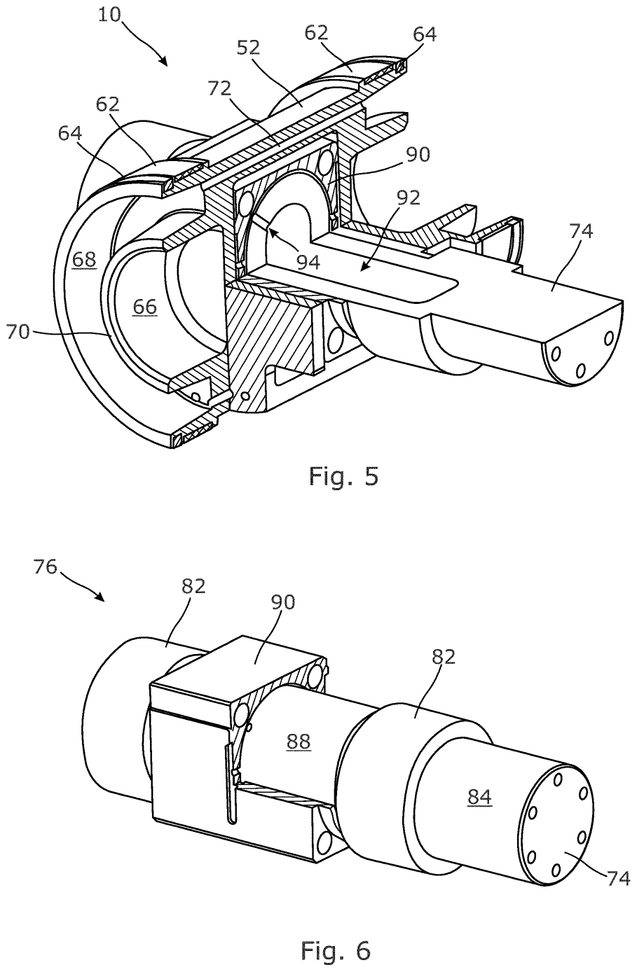

As best shown in FIG. 5, the piston 52 includes generally planar end faces at each end, each end face including a circular recess 66 encircled by an annular recess 68, so that the two recesses 66, 68 are in concentric relation and separated by an annular projection 70. The respective annular recesses 68 of each end of the piston 52 are connected by a circular array of axial passages 72 extending through the piston 52, one of which is visible in FIG. 3.

As noted above, the compressor 10 includes a driveshaft 74 that is coupled to the engine 14 of the vehicle, when assembled in the vehicle arrangement 12. The driveshaft 74 is housed in the second central through-bore of the compressor housing 50. As also noted above, the driveshaft 74 forms part of a drive arrangement 76 of the compressor 10, the drive arrangement 76 being configured to drive reciprocating movement of the piston 52 along the piston axis 56. Accordingly, the second central through-bore defines a drive bore 78 and, in turn, the central axis of the drive bore 78 corresponds to the main axis of the driveshaft 74 and so defines a drive axis 80.

It follows that the piston axis 56 and the drive axis 80 are mutually orthogonal and intersect at the centre of the compressor housing 50. Accordingly, the driveshaft 74 extends through, and so is received within, the piston cavity 58.

As the detail view of FIG. 6 shows best, the driveshaft 74 includes a pair of axially-spaced enlarged portions of equal diameter, which enlarged portions define bearing portions 82. One of the bearing portions 82 is disposed at a distal end of the driveshaft 74, while the other bearing portion 82 is spaced axially inwardly from the proximal end of the driveshaft 74. The bearing portions 82 cooperate with corresponding portions of the drive bore 78 to form journal bearings that support rotation of the driveshaft 74 in operation, one of which bearings is visible in FIG. 3.

The spacing of the bearing portion 82 from the proximal end of the driveshaft 74 creates an end portion 84 of the driveshaft 74 of smaller diameter than the bearing portions 82. As FIG. 2 shows, the end portion 84 protrudes externally of the compressor housing 50 to provide a coupling by which the driveshaft 74 is driven by the engine crankshaft, via the clutch 30. In this respect, mechanical coupling between the clutch 30 and the driveshaft end portion 84 may be effected in any suitable manner to transfer torque from the crankshaft to the driveshaft 74, as represented by the coupling 28 shown in FIG. 1.

As FIG. 2 also shows, locking rings 86 are fitted at each end of the drive bore 78. The locking rings 86 each have central openings of narrower diameter than the bearing portions 82 of the driveshaft 74, so that the locking rings 86 restrain the driveshaft 74 against axial movement and thereby hold the driveshaft 74 in place. Returning to FIG. 6, between the bearing portions 82, the driveshaft 74 includes an eccentric portion having an axis that is radially offset from the drive axis 80, the eccentric portion defining a drive cam 88. The drive cam 88 supports a yoke 90 that is mounted to the drive cam 88.

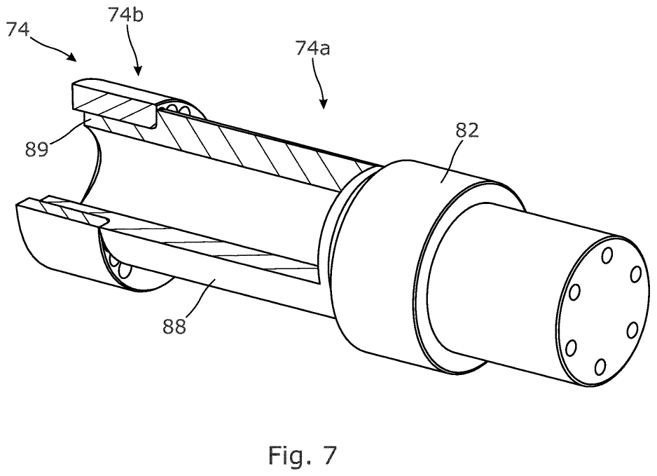

In this respect, as FIG. 7 shows the driveshaft 74 is formed in two parts, including a first part 74a and a second part 74b. The first part 74a defines the majority of the driveshaft 74, including the drive cam 88 and one of the bearing portions 82, while the second part 74b is in the form of a ring that defines the remaining bearing portion 82. The first part 74a includes an end portion 89 of reduced diameter that is received as a press fit in the second part 74b to form the driveshaft 74. During assembly, the yoke 90 is fitted onto the drive cam 88 of the first part of the driveshaft 74, and then the first and second parts 74a, 74b of the driveshaft are brought together to form the driveshaft 74 and thereby hold the yoke 90 captive on the driveshaft 74.

The yoke 90 is of a size and shape corresponding to that of the piston cavity 58 and, as FIG. 5 shows most clearly, locates within the piston cavity 58 in a close sliding fit.

More specifically, the width of the yoke 90, namely its dimension along the piston axis 56, substantially matches the width of the piston cavity 58, so that planar side faces of the yoke 90 engage corresponding planar inner walls of the piston cavity 58. Accordingly, the piston cavity 58 holds the yoke 90 in a fixed orientation with respect to the drive axis 80. The height of the yoke 90, namely its vertical dimension in the orientation shown in FIG. 5, is less than the height of the piston cavity 58, creating a clearance between planar upper and lower end faces of the yoke 90 and corresponding planar inner walls of the piston cavity 58. This clearance allows for vertical sliding of the yoke 90 relative to the piston cavity 58.

In this respect, as the drive cam 88 rotates the yoke 90 traverses a circular path and so moves both horizontally and vertically. Allowing the yoke 90 to slide vertically within the piston cavity 58 accommodates the vertical component of the movement of the yoke 90. Meanwhile, the engagement between the side faces of the yoke 90 and the walls of the piston cavity 58 transfers a drive force from the yoke 90 to the piston 52 in the direction of the piston axis 56 as the drive shaft rotates.

It follows from the above that, in this embodiment, the driveshaft 74 and the yoke 90 together form the drive arrangement 76 that drives movement of the piston 52 and, in turn, operation of the compressor 10.

Referring to FIG. 5, a portion of the driveshaft 74 is hollow and thus includes an internal volume 92. The internal volume 92 reduces the mass of the driveshaft 74 and may also help to balance the shaft in operation. The internal volume 92 is also used as a route to feed lubricating oil in this embodiment. In this respect, FIG. 5 also shows a small radial passage 94 connecting the internal volume 92 with the exterior of the driveshaft 74, enabling lubricating oil to be conveyed to the driveshaft exterior and into the compressor 10 through a feed path comprising a series of further passages and clearances that are not detailed here in the interests of clarity. For example, lubricating oil can reach the guide rings 62 through the clearance between the piston 52 and the piston bore 54 in the region between the guide rings 62. The feed path leads to an oil discharge port (not shown), through which oil can exit the compressor 10 to be cooled externally and then recirculated, thereby maintaining the oil temperature within operational limits.

Although not shown in the figures, the driveshaft 74 may also be provided with one or more counter balancing masses in a similar manner to conventional crankshafts.

Turning now to the fluid ports of the compressor 10, each end of the piston bore 54 receives, and is closed by, a respective port assembly 96, the port assemblies 96 being substantially identical to one another. Accordingly, the compressor 10 includes a first port assembly 96a, which is visible and shown to the left in FIG. 2, and a second port assembly 96b, which is at the rear of the housing 50 and therefore largely hidden in FIG. 2. The opposed faces of the compressor housing 50 to which the port assemblies 96 are mounted may therefore be regarded as port faces.

The first port assembly 96a includes a first head member 98a that is held in position by a first retention collar 100a. Correspondingly, the second port assembly includes a second head member 98b that is held in position by a second retention collar 100b. The first head member 98a and the first retention collar 100a are described below, but it should be appreciated that the second head member 98b and the second retention collar 100b are configured in the same way in this embodiment.

The first retention collar 100a is defined by an annular member that includes a circular array of axial drillings 102, which drillings 102 align with corresponding threaded holes 104 in the wall of the compressor housing 50, to enable the retention collar 100a, and in turn the first port assembly 96a, to be fixed to the compressor housing 50 using bolts in this example.

The first head member 98a is a generally cylindrical member that is received concentrically within the first retention collar 100a. In this respect, the head member 98 includes an end region 106 of a diameter that is sized for a close fit with the retention collar 100a, but with a small radial clearance.

The first head member 98a also includes a radial flange 108 at an end of the end region, the flange 108 being configured to fit into and engage a complementarily-shaped recess formed around an inner edge of the first retention collar 100a where the collar engages the housing 50. Accordingly, engagement between the flange 108 of the first head member 98a and the recess of the first retention collar 100a prevents axially outward movement of the head member 98a from the housing 50. Correspondingly, a snap-in ring 110 on the exterior of the end region 106 of the head member 98a engages the exterior face of the first retention collar 100a to prevent axially inward movement of the head member 98a, so that the radial flange and the snap-in ring 110 together fix the axial position of the head member 98a relative to the first retention collar 100a.

By virtue of the radial clearance between each head member 98 and the associated retention collar 100, the head member 98 is able to move, or ‘float’, relative to the retention collar 100, in the sense of radial movement or rotation relative to the piston axis 56. This allows each head member 98 to reposition to accommodate thermal expansion and elastic distortion of components of the compressor 10 in operation, thereby mitigating side loads on the head members 98 and reducing friction and wear. Moreover, since each head member 98 is able to float, misalignment of the head members 98 can self-correct.

Beyond the flange, the first head member 98a further includes a cylindrical spigot 112 of a smaller diameter than either the flange or the end region 106 of the head member 98a, the spigot 112 being coaxial with the flange and the end region 106. As seen best in FIG. 3, the first head member 98a includes a pair of through-holes 114 that extend axially through the head member 98a, from a first end face on the end region 106 of the head member 98a to a second end face on the spigot 112. The through-holes 114 are of similar diameter to one another and have respective axes that are parallel to, and equispaced across, a central axis of the first head member 98a, which is coaxial with the piston axis 56. As FIG. 2 shows, the through-holes 114 each open into a common slot-like opening 116 on the exterior face of the end region 106 of the first head member 98a.

Each through-hole holds a respective tube member, a first of these tube members defining a first inlet 118a and the remaining tube member defining a first outlet 120a. The tube members defining the first inlet 118a and the first outlet 120a each protrude outwardly from the first head member 98a, to equal extents, to define ports for making fluid connections. Accordingly, a protruding portion of the first inlet 118a defines a first inlet port 122a and, correspondingly, a protruding portion of the first outlet 120a defines a first outlet port 124a.

The first port assembly 96a is mounted to the side of the compressor housing 50 so that the first inlet 118a and the first outlet 120a are arranged one above the other in vertical succession in the orientation shown in FIG. 2, the inlets 118 being on top in this example.

As noted above, the second port assembly 96b is substantially identical to the first port assembly 96a, and so comprises a second inlet 118b defining a second inlet port 122b and a second outlet 120b defining a second outlet port 124b. The second port assembly 96b is mounted to the opposed side of the compressor housing 50 in a similar manner to the first port assembly 96a. Accordingly, the first and second inlets 118 are mutually coaxial on, and spaced along, an axis defining an inlet axis, which is parallel to and radially spaced from the piston axis 56. Correspondingly, the first and second outlets 120 are mutually coaxial and spaced along an outlet axis. The inlet and outlet axes are mutually parallel and extend in a common plane that bisects the compressor housing 50 centrally, that plane being oriented vertically in the orientation shown in FIG. 2.

Due to the similarity of the first and second port assemblies 96 and the central configuration of the drive bore 78, and with the exception of the eccentricity of the drive cam 88, the compressor 10 is substantially symmetrical about a central plane of symmetry extending parallel to the port faces and containing the drive axis 80. The first and second inlet ports 122 each serve to facilitate fluid coupling of the associated inlet 118 to the inlet line 22 of the fuel delivery arrangement 16, so that the inlets 118 can receive fuel from the fuel tank 18. Correspondingly, the first and second outlet ports 124 each facilitate fluid coupling of the associated outlet 120 to the outlet line 24 of the fuel delivery arrangement 16, to enable the compressor 10 to deliver pressurised fuel to the outlet line 24 and the buffer tank 20 and, ultimately, the engine 14.

Inside the compressor housing 50, the respective spigots 112 of the head members 98 of each port assembly extend towards one another along the piston axis 56. Each spigot 112 is received within a respective circular recess 66 of the piston end face, each spigot 112 being arranged as a sliding fit with the corresponding annular projection 70 of the piston 52 so that the projection 70 and the spigot 112 are in telescopic relation.

Accordingly, the piston 52 is supported between the spigots 112 of the head members 98, the spigots 112 and the annular projections 70 being sized to accommodate the back-and-forth movement of the piston 52 along its axis in operation. The spigots 112 and the guide rings 62 therefore collectively guide movement of the piston 52 along the piston axis 56.

The cylindrical volume of each circular recess 66 of the piston 52, once closed by the associated spigot 112, defines a compression chamber 130. Accordingly, the compressor 10 comprises a first compression chamber 130a disposed between the piston 52 and the first port assembly 96a, and a second compression chamber 130b disposed between the piston 52 and the second port assembly 96b. The first and second compression chambers 130 are therefore axially spaced along the piston axis 56, at opposed ends of the piston 52, and are therefore separated by the piston 52.

Each spigot 112 includes an annular groove 132 on its tubular exterior, which groove 132 receives an inner sealing ring 134 that creates a sliding fluid seal between the spigot 112 and the annular projection 70, thereby sealing the compression chamber 130 from the other parts of the compressor 10. Due to the proximity of the inner sealing rings 134 to the fuel in the compression chambers 130, the inner sealing rings 134 may be lubricated using water or another fluid other than oil.

As the piston 52 slides back-and-forth in operation under the action of the drive cam 88 and the yoke 90, relative movement between each annular projection 70 and the corresponding spigot 112 entails that the spigot 112 effectively moves in and out of the associated compression chamber. This causes sinusoidal variation in the volume of the compression chamber, in a similar manner to the combustion chambers of the engine 14. Accordingly, inward movement of a spigot 112 into its associated compression chamber 130 defines a compression stroke, in which the volume of the chamber reduces and thus fuel contained in the compression chamber 130 is compressed, and outward movement of the spigot 112 from the compression chamber 130 defines an expansion stroke as the volume of the chamber increases.

It follows that the compression chambers 130 operate 180° out-of-phase with one another, since movement of the piston 52 in either direction corresponds to a compression stroke for one of the compression chambers 130 and an expansion stroke for the other compression chamber.

Referring specifically to the first compression chamber 130a as shown in FIG. 3, the through-holes 114 associated with the first inlet 118a and the first outlet 120a extend through the first head member 98a and open into the first compression chamber 130a. Accordingly, the first inlet 118a and the first outlet 120a are each in fluid communication with the first compression chamber 130a.

An inlet non-return valve 136 is positioned between the first inlet 118a and the first compression chamber 130a. The inlet non-return valve 136 permits fuel to flow into the first compression chamber 130a through the first inlet 118a, but resists backflow from the first compression chamber 130a into the first inlet 118a. Correspondingly, an outlet non-return valve 138 is positioned between the first outlet 120a and the first compression chamber 130a. The outlet non-return valve 138 permits fuel to flow from the first compression chamber 130a into the first outlet 120a, but resists flow into the first compression chamber 130a from the first outlet 120a.

Accordingly, during expansion strokes fuel is drawn into the first compression chamber 130a through the first inlet 118a while the first outlet 120a is effectively closed by the outlet non-return valve 138. Correspondingly, during compression strokes fuel is discharged from the first compression chamber 130a through the first outlet 120a while the first inlet 118a is effectively closed by the inlet non-return valve 136.

The second port assembly 96b and the second compression chamber 130b are configured in a similar manner to the first port assembly 96a and the first compression chamber 130a. Accordingly, each compression chamber 130 has a respective inlet non-return valve 136 and a respective outlet non-return valve 138, the inlet and outlet non-return valves collectively preventing cross-flow of fuel between the compression chambers 130.

Accordingly, in operation fuel is discharged from the first and second outlets 120 alternately in regular pulses at a frequency corresponding to twice the engine speed, noting that each revolution of the driveshaft 74 corresponds to two compression strokes of the piston 52. Similarly, fuel is drawn into the first and second inlets 118 from the inlet line 22 in corresponding alternating pulses. In this way, the compressor 10 delivers a relatively steady output that is substantially continuous, since fuel discharge from each compression chamber 130 begins at the precise moment at which discharge from the other compression chamber 130 ends on each piston stroke.

Arranging the compression chambers 130 at opposed ends of the piston 52 beneficially balances the forces acting on the piston 52 and other moving parts of the compressor 10 to some extent, in that the pressure of the incoming fuel in the expanding chamber balances the pressure that is being developed in the chamber undergoing a compression event, thereby reducing the demands placed on the drive arrangement 76. The load on the drive arrangement 76 is therefore related to the difference between the inlet pressure and the outlet pressure, namely the pressure ratio. Hence, the drive arrangement 76 may operate particularly efficiently when the pressure ratio is low.

It follows that having opposed compression chambers 130 also mitigates the impact of the variation in the pressure ratio that arises due to fluctuations in the inlet pressure, noting that the output pressure is relatively steady. In particular, as the pressure ratio approaches one, the forces on each side of the piston 52 come into balance and so the drive arrangement 76 need only overcome the difference in these forces, and friction and inertia, to move the piston 52. Similarly, the arrangement promotes favourable running conditions for the bearings of the compressor 10, which are not subject to the full forces of each compression chamber 130 but instead need only withstand the difference between the forces arising in the chambers 130.

It also follows from this that the forces on each side of the piston 52 balance entirely when the compressor 10 is operated in the idling mode, in which the pressure ratio is one or very close to one, meaning that the drive arrangement 76 need only overcome frictional and inertial forces to move the piston 52.

Moreover, arranging the compression chambers 130 to share a common piston 52 promotes a compact topology, enabling a significant size reduction relative to known compressors and thereby reducing packaging demands in the vehicle. Similarly, mounting the piston 52 directly onto the driveshaft 74 avoids the need for coupling rods and the like, and so further promotes a compact arrangement.

The compressor 10 includes various sliding interfaces between moving components, which are lubricated to minimise frictional losses and wear. As noted above, lubricating oil is introduced through the internal volume 92 of the driveshaft 74 and then distributed along a feed path to some of the moving components of the compressor 10, particularly the yoke 90 and the outer guide rings 62 of the piston 52. It is also possible to force lubricating oil through the compressor 10 using an oil pump to urge oil into the driveshaft 74 and along the feed path. This may be useful in demanding operating scenarios, such as when the combined load in the compression chambers 130 is high, for example when the inlet pressure is low, and the compressor 10 is operating at relatively low speed.

However, unlike in pumps for liquid fuel, as noted above in a compressor 10 for gaseous fuel mixing of the oil and the fuel should be avoided, or at least minimised. Accordingly, the feed path is terminated before oil reaches areas of the compressor 10 where it may come into contact with fuel, so that the compressor 10 is notionally divided into an oil zone and fuel zones.

The oil zone includes the piston cavity 58 and therefore the interfaces between the yoke 90 and the piston 52, and also the exterior of the piston 52 and therefore the guide rings 62.

The fuel zones are defined by the compression chambers 130, the boundaries of which are defined by the seals created by the inner sealing rings 134 between the spigots 112 and the annular projections 70 of the piston 52. Hence, as noted above these seals are lubricated using water in this example.

In operation, some oil may cross the seals formed by the outer sealing rings 64 as the piston 52 reciprocates, which oil could threaten to flow on to the fuel zone and so mix with fuel. To avoid this, the annular recesses 68 in each end face of the piston 52 and the associated connecting passages 72 create a venting arrangement that creates a barrier to oil crossing the guide rings 62 and the outer sealing rings 64 and that returns such oil to the oil zone. The annular recesses 68 therefore define vent chambers 68 and the connecting passages 72 define vent passages 72.

A flow of air is created through the vent passages 72, which flow follows a continuous circular path that extends around the guide rings 62 and through the vent chambers 68 and passages 72. The air flow may be induced by movement of the piston 52 or by an external air pump. If the air flow is to be induced by movement of the piston 52, valves (not shown) may be provided to control the flow. In either case, the air flow causes any oil reaching the vent chambers 68 to flow back to the guide rings 62 to return to the oil zone, thus preventing the oil from flowing from either vent chamber 68 towards the first or second compression chamber. In this way, the venting arrangement acts as an oil diverting arrangement that diverts oil flowing from the direction of the driveshaft 74 and the drive cam 88 away from the compression chambers 130.

The venting air flow may also have the auxiliary benefit of cooling the compression chambers 130 and thus contributing to thermal management for the compressor 10.

The venting arrangement is also configured to cater for injection of the non-oil lubricant used for the inner sealing rings 134 in this embodiment. In this respect, water may be sprinkled into a flow of air conveyed into the venting arrangement, for example.

It is noted that the seals created by the outer sealing rings 64 that separate the oil zone from the venting arrangement are located on a different diameter to the seals created by the inner sealing rings 134 that separate the venting arrangement from the compression chambers 130. This arrangement further promotes a compact design and, in particular, enables the compression chambers 130 to be sized independently of the size of the yoke 90 and other drive arrangement components. It also helps to prevent contamination of fuel with oil.

The components of the compressor 10 may be fabricated from any suitable materials. For example, in the above described embodiment the housing 50, the piston 52, the driveshaft 74, the yoke 90, the locking rings 86 and the main elements of the port assemblies 96 are all of steel.

It will be appreciated that various other embodiments of the invention are also envisaged without departing from the scope of the appended claims.

For example, although in the above described embodiment the compressor has two inlet ports that are connected to the inlet line of the fuel delivery arrangement, it is also possible for the compressor to have a single inlet port that receives fuel, that inlet port being fluidly connected to each of the compression chambers. Similarly, the compressor may have a single outlet port connected to each of the compression chambers. In such arrangements, each compression chamber may still be provided with respective inlet and outlet valves to control flow of fuel into and out from the chamber and to prevent cross-flow between the chambers.

In another variant, instead of a driveshaft and a yoke alternative drive arrangements are possible for driving movement of the piston. The piston could be moved using electromotive forces, for example.

Additionally, an actuated valve could be used for the outlet valve disposed upstream of the buffer tank on the outlet line, instead of a non-return valve as in the above example. In this case, the actuated valve could be controlled to act in a similar manner to the non-return valve of the above example, for example to open to allow flow from the compressor to the outlet line when appropriate and to close to prevent any backflow from the outlet line into the bypass line. This may entail, for example, closing the outlet valve whenever the bypass valve is open and the compressor is operating, and opening the outlet valve whenever the bypass valve is closed and the compressor is operating, or when the compressor is being bypassed.

Furthermore, other valves (e.g., valves other than non-return valves) may be used for the inlet and outlet valves of the compressor.

### LIST OF PARTS

12—vehicle arrangement
14—engine
16—fuel delivery arrangement
18—fuel tank
20—buffer tank
22—inlet line
24—outline line
26—outlet valve
28—coupling
30—clutch
32—bypass line
34—first end of the bypass line
36—second end of the bypass line
38—bypass valve
40—solenoid actuator for the bypass valve
50—compressor housing
52—piston
54—piston bore
56—piston axis
58—piston cavity
60—radial flanges of the piston
62—guide ring
64—outer sealing ring
66—circular recess of the piston
68—annular recess of the piston
70—annular projection
72—axial passage/vent passage
74—driveshaft
74a—first part of the driveshaft
74b—second part of the driveshaft
76—drive arrangement
78—drive bore
80—drive axis
82—bearing portions of the driveshaft
84—end portion of the driveshaft
86—locking rings
88—drive cam
89—end portion of first part of driveshaft
90—yoke
92—internal volume of the driveshaft
94—radial passage of the driveshaft
96a, 96b—first and second port assemblies
98a, 98b—first and second head members of the port assemblies
100a, 100b—first and second retention collars of the port assemblies
102—retention collar drillings
104—threaded holes
106—end region of head member
108—head member flange
110—snap-in ring
112—spigot of the head member
114—through-holes of the head member
116—slot opening
118a, 118b—first and second inlets
120a, 120b—first and second outlets
122a, 122b—first and second inlet ports
124a, 124b—first and second outlet ports
130a, 130b—first and second compression chambers
132—spigot groove
134—inner sealing ring
136—inlet non-return valve
138—outlet non-return valve

1. A fuel compressor for compressing gaseous vehicle fuel, the fuel compressor comprising:
a housing;
a piston arranged for reciprocating movement along a piston axis within the housing;
a drive arrangement arranged to drive reciprocating movement of the piston along the piston axis;
a first compression chamber in which gaseous fuel is compressed by movement of the piston in a first direction along the piston axis in use; and
a second compression chamber in which gaseous fuel is compressed by movement of the piston in a second direction along the piston axis in use, the first and second compression chambers being mutually spaced along the piston axis so that the first and second compression chambers are arranged at opposed ends of the piston.

2. The compressor of claim 1, wherein the piston is shaped to define each compression chamber, at least partially.

3. The compressor of claim 1 wherein each compression chamber is at least partially enclosed by the piston.

4. The compressor of claim 1, wherein the piston includes a first end face at a first end of the piston and a second end face at a second end of the piston opposite the first end, and wherein the first end face includes a first recess that at least partially defines the first compression chamber and the second end face includes a second recess that at least partially defines the second compression chamber.

5. The compressor of claim 4, wherein each recess defines a cylindrical volume.

6. The compressor of claim 1, wherein the compressor comprises a first head member through which fuel flows into and out from the first compression chamber and a second head member through which fuel flows into and out from the second compression chamber.

7. The compressor of claim 6, wherein:
the piston includes a first end face at a first end of the piston and a second end face at a second end of the piston opposite the first end, and the first end face includes a first recess that at least partially defines the first compression chamber, and the second end face includes a second recess that at least partially defines the second compression chamber; and
the first head member includes a first spigot and the second head member includes a second spigot and wherein the first recess and the first spigot define the first compression chamber and the second recess and the second spigot define the second compression chamber.

8. The compressor of claim 7, wherein the first spigot is received within the first recess and the second spigot is received within the second recess.

9. The compressor of claim 6, wherein the first and second head members are each supported for movement relative to the housing.

10. The compressor of claim 1, wherein the piston is generally cylindrical.

11. The compressor of claim 1, wherein the first and second compression chambers are located inside the piston.

12. The compressor of claim 1, wherein the drive arrangement comprises a drive cam arranged to rotate about a drive axis to drive reciprocating movement of the piston along the piston axis.

13. The compressor of claim 12, comprising a yoke mounted to the drive cam and in sliding engagement with the piston.

14. The compressor of claim 12, wherein the piston axis is orthogonal to the drive axis.

15. The compressor of claim 12, wherein the piston axis and the drive axis intersect.

16. The compressor of claim 1, wherein at least part of the drive arrangement is received within the piston.

17. The compressor of claim 1, comprising an oil diverting arrangement configured to divert oil flowing from the drive arrangement away from the compression chambers.

18. The compressor of claim 17, wherein the oil diverting arrangement comprises at least one vent passage through which a flow of air is conveyed, in use, to divert oil away from the compression chambers.

19. The compressor of claim 18, wherein each of the at least one vent passage extends axially through the piston.

20. The compressor of claim 1, comprising:
a first inlet valve through which fuel is supplied to the first compression chamber in use;
a first outlet valve through which compressed fuel is discharged from the first compression chamber in use;
a second inlet valve through which fuel is supplied to the second compression chamber in use; and
a second outlet valve through which compressed fuel is discharged from the second compression chamber in use.

21. The compressor of claim 1, wherein the drive arrangement is arranged to be coupled to, and driven by, a vehicle engine.

22. A fuel delivery arrangement comprising:
the compressor of claim 1;
an inlet line arranged to convey fuel from a reservoir to each of the compression chambers; and
an outlet line arranged to receive fuel discharged from each of the compression chambers

23. A method of compressing gaseous vehicle fuel, the method comprising:
moving a piston in a first direction along a piston axis to compress gaseous fuel in a first compression chamber; and
moving the piston in a second direction along the piston axis to compress gaseous fuel in a second compression chamber.
